(19) United States
(12) Patent Application Publication
(10) Pub. No.: US 2007/0202369 A1
(43) Pub. Date: Aug. 30, 2007

(54) DIRECT FORMIC ACID FUEL CELL PERFORMING REAL TIME MEASUREMENT AND CONTROL OF CONCENTRATION OF FORMIC ACID AND OPERATION METHOD THEREOF

(75) Inventors: Jaeyoung LEE, Incheon (KR); Jonghee HAN, Seoul (KR); Tae Hoon LIM, Seoul (KR); Suk-Woo NAM, Seoul (KR); Sung Pil YOON, Seongnam-si (KR); Hyoung-Juhn KIM, Suwon-si (KR); Eun Ae CHO, Seoul (KR); Heung Yong HA, Seoul (KR); Seong Ahn HONG, Seoul (KR); In Hwan OH, Seoul (KR); Hyung Chul HAHM, Seoul (KR); Yeong Cheon KIM, Seoul (KR); Sang Yeop LEE, Seoul (KR); Kwang Soo LEE, Gwacheon-si (KR)

Correspondence Address: CANTOR COLBURN, LLP, 55 GRIFFIN ROAD SOUTH, BLOOMFIELD, CT, 06002, US

(73) Assignee: KOREA INSTITUTE OF SCIENCE AND TECHNOLOGY, Seoul (KR)

(21) Appl. No.: 11/554,407

(22) Filed: Oct. 30, 2006

(30) Foreign Application Priority Data
Feb. 27, 2006 (KR) 10-2006-0018927
Apr. 7, 2006 (KR) 10-2006-0031958

(51) Int. Cl. H01M 8/04

(52) U.S. Cl. 429/22; 429/34; 429/13

(57) ABSTRACT

Provided are a direct formic acid fuel cell capable of maintaining performance constantly through implementing the real time measurement and control of formic acid concentration.

### BACKGROUND OF THE INVENTION

1. Field of the Invention

The present invention relates to a direct liquid fuel cell recently being in the limelight as a next generation power source for mobile electronic appliances, and more particularly to a direct formic acid fuel cell performing real time measurement and control of a concentration of formic acid using pH or conductivity.

2. Description of the Related Art

Low-temperature fuel cells are environment-friendly and expected to substitute the existing energy system (e.g., secondary cell or capacitor) under the circumstances that a high power portable power source recently is on the rapid rise.

In particular, among the low-temperature fuel cells, a direct methanol fuel cell has a benefit that it does not need a reformer and can be made smaller due to its simple system.

However, the direct methanol fuel cell also has a problem of degradation in its performance and durability due to a contamination of a cathode and a side reaction resulting from a methanol crossover. Moreover, although a technical solution concerned to the methanol crossover is proposed, it is estimated that the methanol fuel cell is not commercialized in the early time due to regulation in use of the methanol that is noxious to the human body.

Meanwhile, recently, possible substitute of liquid fuels, such as formic acid, ethylene glycol, dimethyl ether, methyl formate, and so forth that can overcome the defects of methanol is under study. Such liquid fuel has an advantage of being innoxious to the human body even though it has relatively low energy density compared to methanol (e.g., while pure methanol has a value of 4690 Wh/L, pure formic acid has a value of 2086 Wh/L).

Furthermore, in case of a formic acid fuel cell that uses a formic acid as a liquid fuel, since the formic acid is dissociated into hydrogen ions and formate ions in an aqueous state, the formic acid itself can be used as an electrolyte that can minimize liquid resistance. Moreover, unlike methanol, the membrane permeation of the formic acid is hardly carried out due to a repulsive force between the formate ions and ion clusters formed on a polymer electrolytic membrane. Accordingly, the formic acid fuel cell has an advantage that it hardly causes the cathode contamination and the side reaction that are considered to be an important problem in the methanol fuel cell. Furthermore, the formic acid fuel cell has a high thermodynamic equilibrium potential (about 1.45 V) and a rapid oxidation reaction rate.

Researches and developments are actively ongoing for using the direct formic acid fuel cell as a portable power system.

The following reactions express ones at an anode and a cathode, respectively, in the direct formic acid fuel cell.

HCOOH->CO₂+2H⁺+2e⁻ [Reaction 1]

2H⁺+2e⁻+0.5O₂->H₂O [Reaction 2]

As can be known from above, at the anode, two electrons and hydrogen ions are produced by an electrochemical oxidation reaction of a formic acid, which hydrogen ions move to the cathode through a polymer electrolytic membrane and are reacted with oxygen supplied to the cathode to produce water. In addition, the created electrons move to the cathode from the anode via all external circuit, and a current usage is determined based on a resistance value.

The formic acid is oxidized into carbon dioxide through two paths of direct and indirect oxidation reactions. However, the research of the formic acid fuel cell has been hitherto focused on development for an optimal catalyst for direct oxidation.

However, as a result of being focused on such narrow research, the research on total process system for commercialization of the direct formic acid fuel cell as a portable power source lies in a deficient level yet.

In particular, although, unlike the direct methanol fuel cell system, the direct formic acid fuel cell inevitably uses a high concentration formic acid, it has not yet been developed measuring and controlling the concentration of formic acid in order to use the high concentration formic acid and operating the formic acid fuel cell based on the measurement and the control.

### SUMMARY OF THE INVENTION

Accordingly, the present invention has been made to solve the above-mentioned problems occurring in the prior art, and an object of the present invention is to provide a direct formic acid fuel cell capable of securing its long-term operability through real time control of the concentration of formic acid, and an operation method thereof.

Another object of the present invention is to provide a formic acid concentration measuring device capable of performing to detect a concentration of formic acid in real time and high sensitivity upon operation of the direct formic acid fuel cell, and having impact resistance, chemical resistance, and weatherability.

In order to accomplish these objects, there is provided a direct formic acid fuel cell comprising: a unit cell composing of an anode, a polymer electrolytic membrane, and a cathode, or a stack of unit cells; a formic acid supply device for supplying formic acid of fuel to the anode of the unit cell; an air/oxygen supply device for supplying air or oxygen to the cathode of the unit cell; a concentration measuring device connected to the formic acid supply device and measuring in real time a concentration of a portion of formic acid to be supplied to the anode; and a controller receiving the value of measured concentration from the concentration measuring device, comparing the measured value with a predetermined range of concentration, and controlling in real time the concentration of formic acid to be supplied to the anode depending upon the real time measurement of the concentration measuring device in such a manner that the measured value does not deviate from the predetermined rage of concentration.

In an embodiment of the present invention, the concentration measuring device is a pH measuring device connected to the formic acid supply device and measuring in real time a pH value of hydrogen ions produced through dissociating a portion of formic acid to be supplied to the anode, and the controller is a controller receiving the pH value measured by the pH measuring device, comparing the measured pH value with a predetermined pH range, and controlling in real time the concentration of formic acid to be supplied to the anode depending upon the real time measurement of the pH measuring device in such a manner that the measured pH value does not deviate from the predetermined pH range.

In an embodiment of the present invention, the concentration measuring device is a conductivity measuring device connected to the formic acid supply device and measuring in real time conductivity values of hydrogen ions and formate ions produced through dissociating a portion of formic acid to be supplied to the anode, and the controller is a controller receiving the conductivity values measured by the conductivity measuring device, comparing the measured conductivity values with a predetermined conductivity range, and controlling in real time the concentration of formic acid to be supplied to the anode depending upon the real time measurement of the conductivity measuring device in such a manner that the measured conductivity values do not deviate from the predetermined conductivity range.

In an embodiment of the present invention, the formic acid supply device comprises: a pure or high concentration formic acid storage unit; an adequate concentration formic acid storage unit supplied with water discharged from the cathode or water from a separate water supply, and connected to the pure or high concentration formic acid storage unit, storing formic acid with the concentration regulated; a valve opening and closing to supply the pure or high concentration formic acid from the pure or high concentration formic acid storage unit to the adequate concentration formic acid storage unit according to a control signal of the controller; and a pump supplying adequate concentration formic acid from the adequate concentration formic acid storage unit to the anode.

In an embodiment of the present invention, the adequate concentration formic acid storage unit is supplied with formic acid discharged from the anode.

In an embodiment of the present invention, the formic acid supply device comprises: a pure or high concentration formic acid storage Unit; a water storage unit storing water discharged from the cathode or water from a separate water supply; a mixer mixing the pure or high concentration formic acid supplied from the pure or high concentration formic acid storage unit with water supplied from the water storage unit to provide adequate concentration formic acid; a pump supplying water from the water storage unit to the mixer according to a control signal of the controller; a pump supplying pure or high concentration formic acid from the pure or high concentration formic acid storage unit to the mixer according to a control signal of the controller; and a pump supplying adequate concentration formic acid from the mixer to the anode.

In an embodiment of the present invention, the mixer is supplied with the formic acid discharged from the anode in order for the formic acid to be mixed together.

In an embodiment of the present invention, the concentration measuring device is a pH measuring device comprising a reference electrode composed of a calomel electrode, an Ag/AgCl electrode, or an Hg/Hg₂SO₄ electrode, and a body electrode composed of fluoro resin and epoxy resin.

In an embodiment of the present invention, an outer cover of the pH measuring device is made of polypropylene (PP), polyvinyl chloride (PVC), polyphenylene sulfide (PPS), carbon, polytetrafluoroethylene (PTFE), ethylene-propylene-diene-terpolymer (EPDM), alumina, nickel, SUS 316, or glass.

In order to accomplish the above objects, there is provided a method of operating a direct formic acid fuel cell, comprises measuring in real time a concentration of a portion of formic acid to be provided to an anode before the formic acid is provided to the anode (S1); and comparing the measured concentration value with a predetermined concentration range, controlling in real time the concentration of formic acid to be supplied to the anode depending upon the real time measurement in such a manner that the measured concentration value does not deviate from the predetermined concentration range, and providing the anode with the formic acid (S2).

In an embodiment of the present invention, in the step S1, a pH value of hydrogen ions produced by dissociating a portion of formic acid is measured in real time before the formic acid is provided to the anode, and in the step S2, the measured pH value is compared with a predetermined pH range, the concentration of formic acid to be supplied to the anode is controlled in real time depending upon the real time pH measurement in such a manner that the measured pH value does not deviate from the predetermined pH range, and provides the anode with the formic acid. In an embodiment of the present invention, the pH measurement is carried out with reliability of 95% or more in connection with the variation in formic acid concentration in such a way that upon variation in formic acid concentration, the measured pH value is stabilized into a constant value within 1 to 5 seconds.

In an embodiment of the present invention, the predetermined pH range is 1.34 to 0.42. In an embodiment of the present invention, in the step S1, conductivity values of hydrogen ions and formate ions produced by dissociating a portion of formic acid is measured in real time before the formic acid is provided to the anode, and in the step S2, the measured conductivity value is compared with a predetermined conductivity range, the concentration of formic acid to be supplied to the anode is controlled in real time depending upon the real time conductivity measurement in such a manner that the measured conductivity values do not deviate from the predetermined conductivity range, and provides the anode with the formic acid.

In an embodiment of the present invention, the conductivity value is stabilized into a constant value within 1 to 5 seconds in connection with variation in formic acid concentration.

In an embodiment of the present invention, the predetermined conductivity range is 9.5 to 12 mS/cm.

### BRIEF DESCRIPTION OF THE DRAWINGS

FIG. 1 is a schematic diagram illustrating a direct formic acid fuel cell according to a first example of the present invention, which performs in real time measurement and control of concentration of formic acid;

FIG. 2 is a schematic diagram illustrating a direct formic acid fuel cell according to a second example of the present invention, which performs in real time measurement and control of concentration of formic acid;

FIG. 3 is a schematic view illustrating a micro pH measuring device, which is adapted to examples of the present invention, for concentration measurement of formic acid of the direct formic acid fuel cell;

FIG. 4 is a schematic view illustrating a micro conductivity measuring device, which is adapted to examples of the present invention, for concentration measurement of formic acid of the direct formic acid fuel cell;

FIG. 5 is a graph illustrating variation in a pH value to the formic acid concentration according to the examples of the invention;

FIG. 6 is a graph illustrating a result of detection response time of formic acid concentration upon pH measurement according to the examples of the invention;

FIG. 7 is a graph illustrating variation in conductivity value to the formic acid concentration according to the examples of the invention; and

FIG. 8 is a graph illustrating a result of detection response time of formic acid concentration upon conductivity measurement according to the examples of the invention.

### DETAILED DESCRIPTION OF THE PREFERRED EMBODIMENTS

Hereinafter, preferred examples of the present invention will be described in detail with reference to the accompanying drawings.

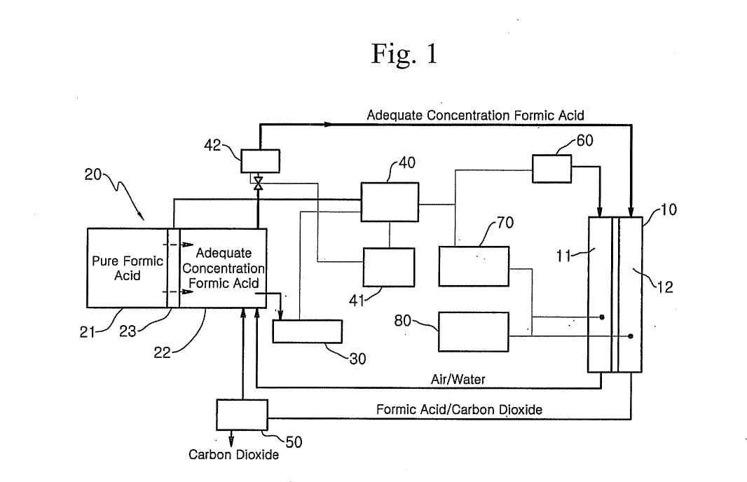

FIG. 1 is a schematic diagram illustrating a direct formic acid fuel cell according to a first example of the present invention, which performs in real time measurement and control of concentration of formic acid.

As illustrated in FIG. 1, the direct formic acid fuel cell according to the first example of the invention comprises a unit cell 10 consisting of all anode 12, a polymer electrolytic membrane and a cathode 11, a formic acid supply device for supplying the anode 12 of the unit cell 10 with formic acid as fuel, an air supply device 60 for supplying the cathode 11 of the unit cell 10 with air (or oxygen, which is also the same case hereinafter), a formic acid concentration measuring device 30, and a controller 40 receiving the concentration value measured by the concentration measuring device 30 to control the concentration of formic acid.

The formic acid supply device comprises a formic acid storage unit 20. The formic acid storage unit 20 comprises a pure (or high concentration, which is also the same case hereinafter) formic acid storage portion 21, an adequate concentration formic acid storage unit 22 that is a buffer zone to which the concentration measuring device 30 is connected, and a switch valve 23 connected to the controller 40 for moving the pure formic acid from the pure formic acid storage portion 21 to the adequate concentration formic acid storage portion 22.

The adequate concentration formic acid storage portion 22 may be introduced with air removed water from water/air discharged from the cathode 11, and furthermore, if necessary, a separate water supply for regulating adequate concentration may be installed to be connected to the adequate concentration formic acid storage portion 22.

Meanwhile, it may be introduced with formic acid in which carbon dioxide is removed from formic acid/carbon dioxide discharged from the anode 12 by a carbon dioxide remover 50.

A pump 42 is connected to the adequate concentration formic acid storage portion 22 in such a manner that it is driven though a pump driver 41 connected to the controller 40.

Herein, considering the size and the chemical energy output of the whole system, it is adequate to make the volume of the pure formic acid storage portion 21 being 270 cc, for example, (e.g., the mol concentration of 100% formic acid is 21.7 M(mol/L) and the chemical energy density thereof is 2086 Wh/L. Therefore, the chemical energy at 270 cc becomes 563.22 Wh). Also, it is preferable that the volume of the adequate concentration formic acid storage portion 22 is set to 30 cc in consideration of the size, the supply amount, and the chemical energy output of the system.

The air supply device 60 is composed of an air plump, which controlled by the controller 40 to supply adequate amount of air to the cathode 11. Preferably, the pump has the volume of 40 to 60 cc and supplies air in 1.5 to 6.8 L/min with the power consumption of 1.5 to 3.0 W.

The controller 40 is composed of a PCB board as sensing/control units.

Meanwhile, a buck converter 70 and a DC-DC converter 80 are respectively connected to the cathode 11 and the anode 12 of the unit cell 10, and also to the controller 40.

The formic acid concentration measuring device 30 is a concentration measuring device for measuring in real time a concentration of formic acid, such as, for example, a pH measuring device for measuring a pH value of hydrogen ions produced by dissociating formic acid.

That is, the pH measuring device 30 measures in real time a pH value of hydrogen ions produced by extracting and dissociating a portion of formic acid from the adequate concentration formic acid storage portion 22. The pH value measured by the pH measuring device 30 is received by the controller 40. The controller 40 compares the measured pH value with a predetermined pH range, such as, for example, pH 1.34 to 0.42 that corresponds to the concentration of 4 M to 10 M of formic acid, and controls opening-and-closing of the valve 23 according to the real time pH measurement of the pH measuring device such that the received pH value does not deviate from the predetermined pH range.

The controller 40 closes the valve 23 if the pH value is 0.42 or less, for example, so that the concentration of formic acid in the adequate concentration formic acid storage portion 22 can be regulated to have the pH value of 0.42 or more because the portion 22 is continuously introduced with water discharged from the cathode 11. In the meantime, the controller 40 opens the valve 23 if the pH value becomes 1.34 or more, for example, and in case where the valve 23 is opened like this, the pH value may be 1.34 or less because pure formic acid is provided thereto together with formic acid provided from the anode.

The formic acid concentration measuring device 30 may be a conductivity measuring device for measuring in real time conductivity of formic acid from hydrogen ions and formate ions produced by extracting a portion of formic acid from the adequate concentration formic acid storage portion 22 and dissociating the same through the reaction with water.

The conductivity value measured by the conductivity measuring device 30 is received by the controller 40. The controller 40 compares the measured value with a predetermined conductivity range, such as, for example, conductivity of 9.5 to 12 mS/cm that corresponds to the concentration of 4 M to 10 M of formic acid, and controls opening-and-closing of the valve 23 according to the real time measurement of the conductivity measuring device such that the received conductivity value does not deviate from the predetermined conductivity range.

Meanwhile, the controller 40 drives the pump 42 through the pump driver 41 connected thereto to provide the anode 12 with adequate concentration formic acid from the adequate concentration formic acid storage portion 22, thereby operating the direct formic acid fuel cell, maintaining the performance thereof constantly.

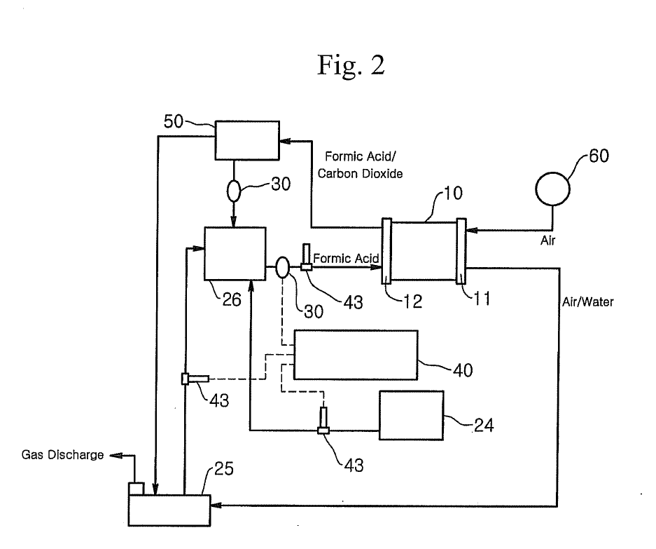

FIG. 2 is a schematic diagram illustrating a direct formic acid fuel cell according to a second example of the present invention, which performs in real time measurement and control of concentration of formic acid.

As illustrated in FIG. 2, the direct formic acid fuel cell according to the second example of the invention comprise a unit cell stack 10 consisting of an anode 12, a polymer electrolytic membrane and a cathode 11, a formic acid supply device for supplying the anode 12 of the unit cell stack 10 with formic acid as fuel, an air supply device 60 for supplying the cathode 11 of the unit cell 10 with air, a formic acid concentration measuring device 30, and a controller 40 performing the control of formic acid concentration base on the concentration value of formic acid measured.

The formic acid supply device according to the second example of the invention is composed of a high concentration formic acid storage portion, a high concentration (or pure, which is also the same case hereinafter) formic acid storage portion 21, a water storage portion 25, and a mixing portion 26 for mixing water with formic acid.

That is, in the second example, water and high concentration formic acid are separately stored, and mixed with each other in adequate concentration in the mixing portion 26 in connection with the concentration measurement of formic acid. At this time, a micro pump 43 is installed to transfer water, high concentration formic acid, or adequate concentration formic acid mixed, respectively, and which is connected to the controller 40.

Preferably, the micro pump 43 has a volume of 30 to 50 cc, and can supply flow in 15 to 40 cc/min with the power consumption of 0.5 to 1.5 W.

The water storage portion 25 is introduced with water/air discharged from the cathode 11. Herein, air is discharged therefrom. Of course, like in the first example, it is possible to additionally install a separate water supply device.

Meanwhile, carbon dioxide is removed from formic acid/carbon dioxide discharged from the anode 12 by a carbon dioxide remover 50. The removed carbon dioxide can be moved to the water storage portion 25 and discharged in gas state. Then, the remaining formic acid from the anode in which carbon dioxide is removed may be re-introduced into the mixing portion 26, and in this case, a formic acid concentration measuring device 30 may be additionally installed to measure a concentration of formic acid re-introduced.

The micro pump 43 is connected to the mixing portion 26, and by which adequate concentration formic acid in the mixing portion 26 is supplied to the anode 12.

Like in the first example, the air supply device 60 is an air pump for supplying the cathode 11 with air in constant flow.

As in the same case as the first example, the formic acid concentration measuring device 30 in the second example can be a pH measuring device. Herein, the pH measuring device 30 connected to the mixing portion 26 measures in real time a pH value of hydrogen ions produced by dissociating a portion of formic acid to be supplied to the anode 12, and provides measured data to the controller 40.

The controller 40 receives the pH value measured from the pH measuring device 30, compares the measured pH value with a predetermined pH range (for example, pH 1.34 to 0.42 as in the first embodiment), and controls the respective pumps 43 in connection with the real time measurement of the pH measuring device such that the measured pH value does not deviate from the predetermined pH range to supply the mixing portion 26 with water and high concentration formic acid, thereby controlling the concentration of formic acid in real time.

Meanwhile, the formic acid concentration measuring device 30 can be a conductivity measuring device. Herein, the conductivity measuring device 30 connected to the mixing portion 26 measures in real time conductivity values of hydrogen ions and formate ions produced by dissociating a portion of formic acid to be supplied to the anode 12, and provides measured data to the controller 40.

The controller 40 receives the conductivity values measured from the conductivity measuring device 30, compares the measured values with a predetermined conductivity range (for example, 9.5 to 12 mS/cm as in the first embodiment), and controls the respective pumps 43 in connection with the real time measurement of the conductivity measuring device such that the measured values do not deviate from the predetermined conductivity range to supply the mixing portion 26 with water and high concentration formic acid, thereby controlling the concentration of formic acid in real time.

As described above, the direct formic acid fuel cells according to the examples of the invention control the concentration of formic acid through adequately mixing pure or high concentration formic acid and water from the cathode (or water separately supplied from other portion), and furthermore, unreacted formic acid from the anode with each other, base on the formic acid concentration value measured from the formic acid concentration measuring device such as pH measuring device or conductivity measuring device.

Moreover, the pH measuring device or the conductivity measuring device for operating the direct formic acid fuel cell in the examples has high sensitivity capable of real time detection, and furthermore, has impact resistance, chemical resistance, and weatherability.

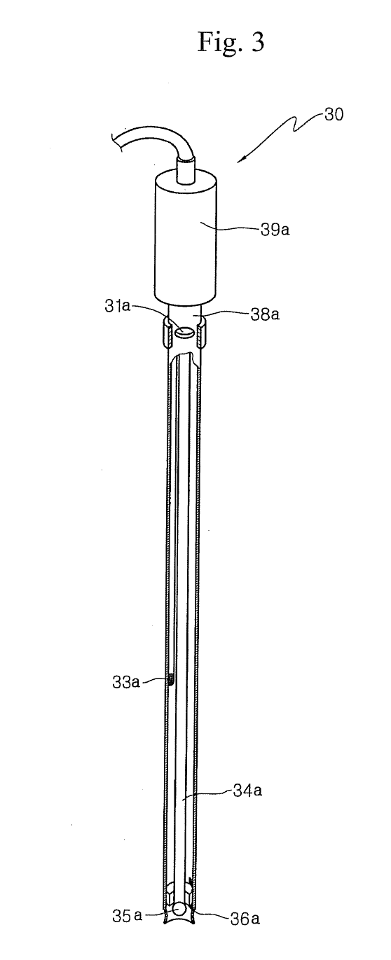

FIG. 3 is a schematic view illustrating a micro pH measuring device, which is adapted to examples of the present invention, for concentration measurement of formic acid of the direct formic acid fuel cell.

As illustrated in FIG. 3, the pH measuring device includes, at a portion of the upper portion of an outer cover tinder a grip portion 39a, a charging hole 31a and a cap 38a thereof. Under the outer cover, a reference electrode 33a and a body electrode 34a are provided. A glass electrode bulb 35a is mounted below the body electrode 34a, and around which a reference contact 36a is provided.

The reference electrode 33a is preferably composed of a calomel electrode, an Ag/AgCl electrode, or an Hg/Hg₂SO₄ electrode, and the body electrode 34a is preferably composed of fluoro resin and epoxy resin.

In case that the calomel reference electrode is used, the micro pH measuring device has excellent susceptibility for hydrogen ions. Further, the calomel electrode can measure a pH value even in temperature change of 0 to 80° C. or more, and unlike a Pt reference electrode having no good sensor susceptibility in strong acid and strong alkali, it can be adapted to the strong acid solution and strong alkali solution without reduction in susceptibility.

Meanwhile, other than the calomel electrode, the Ag/AgCl electrode or the Hg/Hg₂SO₄ electrode can be used. The Ag/AgCl electrode is economical because it is cheap while having the same as the calomel electrode or the similar performance to the calomel electrode, and the Hg/Hg₂SO₄ electrode is preferable under the circumstances, in particular, where chlorine ions should be considered.

It is preferable to fabricate the body electrode using fluoro resin and epoxy resin in order not to cause a side reaction in the strong acid, and in this case, it has an excellent electric insulating property and a light weight.

Meanwhile, in order to resist the formic acid of strong acid, the pH measuring device is preferably made of polypropylene (PP), polyvinyl chloride (PVC), polyphenylene sulfide (PPS), carbon, polytetrafluoroethylene (PTFE), ethylene-propylene-diene-telpolylmer (EPDM), alumina, nickel, SUS 316, or glass.

Although being different according to a use purpose and a space, an outermost diameter of the micro pH measuring device as illustrated in FIG. 3 preferably has a diameter of about 1.0 to 2.8 mm, a length of 5 to 150 nm, and a volume of 5 to 20 cc due to the restriction to the size or volume of the formic acid fuel cell system (particular, a fuel vessel of a fuel supply device).

With the installation of the above micro pH measuring device on an outlet of the formic acid supply device (the outlet at the side of supplying to the anode), it is possible to detect the concentration of formic acid supplied to the anode as possible as it is mixed to the maximum.

Meanwhile, in order to measure a reliable pH value according to a temperature of formic acid solution, it is preferable to measure a pH value after a temperature of formic acid bath is detected and a cooling fall is operated base on the detected temperature to control the temperature of the formic acid bath. In this case, in order to increase the susceptibility for the solution to the maximum, the contact of the pH measuring device with the solution is made into a structure as wide as possible to facilitate the contact between the pH measuring device and the solution. As such structure, it is possible to adapt a structure in which, for example, a distal contact portion of a sensor is bent into a spoon shape.

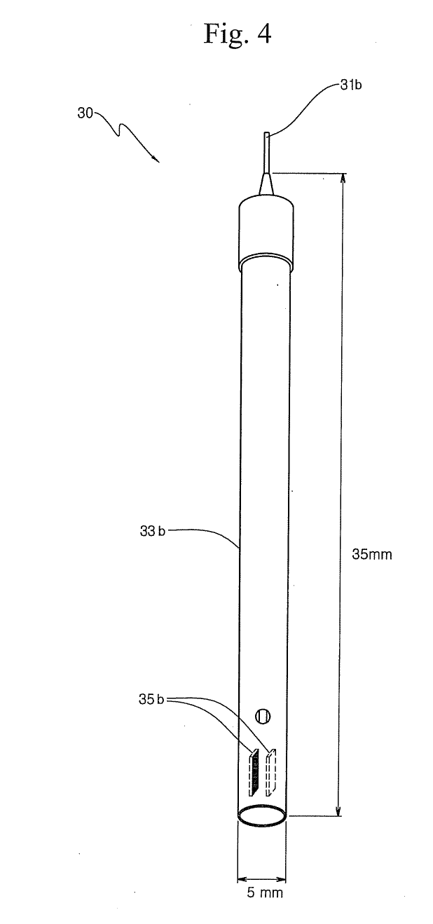

FIG. 4 is a schematic view illustrating a micro conductivity measuring device, which is adapted to examples of the present invention, for concentration measurement of formic acid of the direct formic acid fuel cell.

Al illustrated in FIG. 4, the conductivity measuring device used in the examples of the invention is a measuring device having a body portion with, for example, a length of 35 mm and a diameter device of 5 μm, connected to a cable 31b, in which device the plates 35b are opposed to each other on which platinum black on a glass stem is coated in order to measure conductivity. A body cover 33b of the conductivity measuring device is composed of epoxy resin.

With the installation of the above micro conductivity measuring device on an outlet of the formic acid supply device (the outlet at the side of supplying to the anode), it is possible to detect the concentration of formic acid supplied to the anode as possible as it is mixed to the maximum.

Further, in order to measure a reliable conductivity value according to a temperature of formic acid solution, it is preferable to measure a conductivity value after a temperature of formic acid bath is detected and a cooling fan is operated base on the detected temperature to control the temperature of the formic acid bath. In this case, in order to increase the susceptibility for the solution to the maximum, the contact of the conductivity measuring device with the solution is made into a structure as smooth as possible to facilitate the contact between the conduct measuring device and the solution. As such structure, it is possible to adapt a structure in which, for example, a distal contact portion of a sensor is bent into a spoon shape.

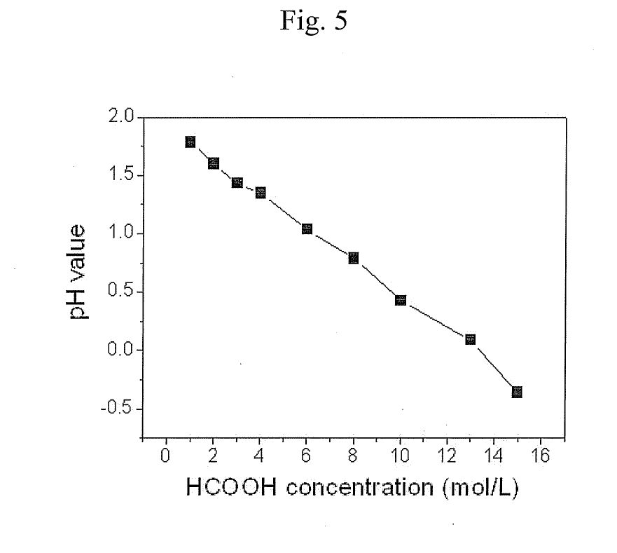

FIG. 5 is a graph illustrating variation in a pH value to the formic acid concentration according to the examples of the invention. As illustrated in FIG. 5, it can be known that as the concentration of formic acid increases, a pH value decreases linearly. Such relation can be expressed as equation 1 below.

Y=1.91407−0.14674×X (Y=pH value, and X—HCOOH concentration) [Equation 1]

Herein, it can be known that in case of 4 M, the pH value is 1.34, and in case of 6 M, 8 M, and 10 M, the pH values decrease to 1.03, 0.78, and 0.42, respectively. An error of measurement for each value is ±0.01 and has a reliability of about 98%.

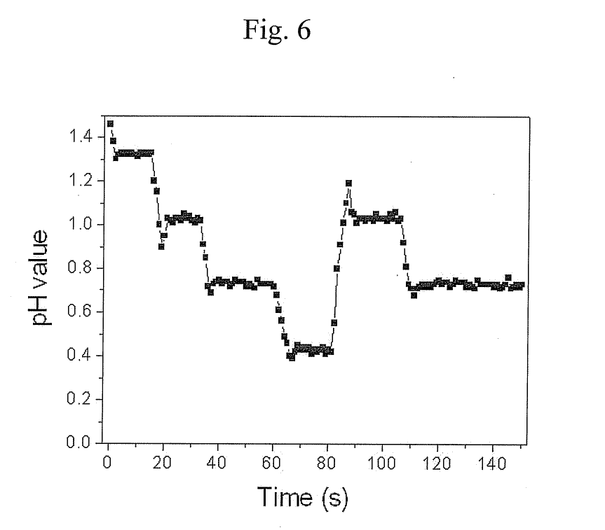

FIG. 6 is a graph illustrating a result of detection response time of formic acid concentration upon pH measurement according to the examples of the invention, in which susceptibility and stability according to rapid variation in formic acid concentration are measured and indicated.

As illustrated in FIG. 6, it is seen that in a variation of formic acid concentration corresponding to 4 M, 6 M, 8 M, 10 M, 6 M, and 8 M in order, the pH values are stabilized within 1 to 5 seconds. Like this, according to the present invention, constant concentration of formic acid can be maintained by such a delicate measurement and control of variation in formic acid concentration.

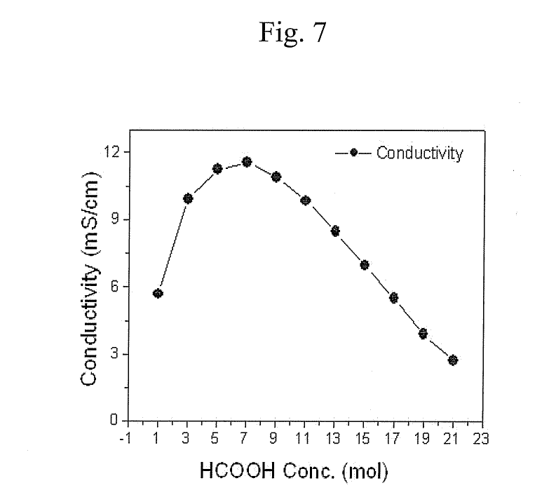

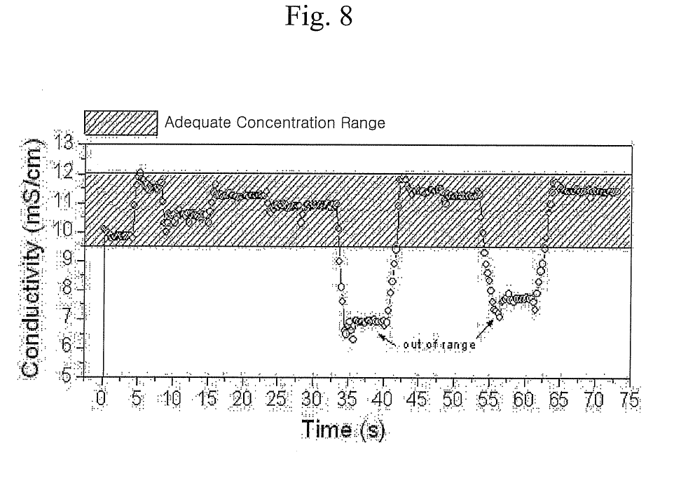

FIG. 7 is a graph illustrating variation in conductivity value to the formic acid concentration according to the examples of the invention, and FIG. 8 is a graph illustrating a result of detection response time of formic acid concentration upon conductivity measurement according to the examples of the invention.

As illustrated in FIGS. 7 and 8, it can be seen that as the concentration of formic acid varies, the conductivity values are stabilized within 1 to 5 seconds. Although there are the cases of 15.0 M and 2.0 M, an adequate concentration range is 4 to 10 M, and the corresponding conductivity is 9.5 to 12 mS/cm. The reliability of said measurement for conductivity is 95% or more. Like this, according to the invention, the variation in formic acid concentration is precisely measured and controlled within 5 seconds (for example, 1 to 5 seconds) with high reliability, thereby maintaining a constant concentration of formic acid.

As set forth before, according to the present invention, a concentration of formic acid is measured in real time and controlled in real time based on such measurement so that a direct formic acid fuel cell can be operated in constant performance. Moreover, with pH or conductivity measurement, it may provide high reliability upon the measurement of formic acid concentration even upon variation in temperature or concentration.

With the construction in which a concentration of formic acid is measured in real time and the concentration of formic acid supplied to an anode is controlled in real time based on such measurement, performance of a direct formic acid fuel cell can be maintained constantly. Furthermore, a micro conductivity measuring device or a pH measuring device for the concentration measurement of formic acid according to the present invention has resistance to strong acid, and has high reliability to variation in temperature or concentration. Moreover, the present invention can be utilized as a reference material for optimum regulation of fuel concentration in other similar liquid fuel cell systems.

What is claimed is:

1. A direct formic acid fuel cell comprising:
a unit cell composing of an anode, a polymer electrolytic membrane, and a cathode, or a stack of the unit cells;
a formic acid supply device for supplying formic acid, which is fuel, to the anode of the unit cell;
an air/oxygen supply device for supplying air or oxygen to the cathode of the unit cell;
a concentration measuring device connected to the formic acid supply device and measuring in real time a concentration of a portion of formic acid to be supplied to the anode; and
a controller receiving the measured concentration value from the concentration measuring device, comparing the measured value with a predetermined range of concentration, and controlling in real time the concentration of formic acid to be supplied to the anode depending upon the real time measurement of the concentration measuring device in such a manner that the measured value does not deviate from the predetermined rage of concentration.

2. The direct formic acid fuel cell according to claim 1, wherein the concentration measuring device is a pH measuring device connected to the formic acid supply device and measuring in real time a pH value of hydrogen ions produced through dissociating a portion of formic acid to be supplied to the anode, and the controller is a controller receiving the pH value measured by the pH measuring device, comparing the measured pH value with a predetermined pH range, and controlling in real time the concentration of formic acid to be supplied to the anode depending upon the real time measurement of the pH measuring device in such a manner that the measured pH value does not deviate from the predetermined pH range.

3. The direct formic acid fuel cell according to claim 1, wherein the concentration measuring device is a conductivity measuring device connected to the formic acid supply device and measuring in real time conductivity values of hydrogen ions and formate ions produced through dissociating a portion of formic acid to be supplied to the anode, and the controller is a controller receiving the conductivity values measured by the conductivity measuring device, comparing the measured conductivity values with a predetermined conductivity range, and controlling in real time the concentration of formic acid to be supplied to the anode depending upon the real time measurement of the conductivity measuring device in such a manner that the measured conductivity values do not deviate from the predetermined conductivity range.

4. The direct formic acid fuel cell according to claim 1, wherein the formic acid supply device comprises:
a pure or high concentration formic acid storage unit;
an adequate concentration formic acid storage unit supplied with water discharged from the cathode or water from a separate water supply, and connected to the pure or high concentration formic acid storage unit, and storing formic acid with its concentration regulated;
a valve opening and closing to supply the pure or high concentration formic acid from the pure or high concentration formic acid storage unit to the adequate concentration formic acid storage unit according to a control signal of the controller; and
a pump supplying adequate concentration formic acid from the adequate concentration formic acid storage unit to the anode.

5. The direct formic acid fuel cell according to claim 4, wherein the adequate concentration formic acid storage unit is supplied with formic acid discharged from the anode.

6. The direct formic acid fuel cell according to claim 1, wherein the formic acid supply device comprises:
a pure or high concentration formic acid storage unit;
a water storage unit storing water discharged from the cathode or water from a separate water supply;
a mixer mixing the pure or high concentration formic acid supplied from the pure or high concentration formic acid storage unit with water supplied from the water storage unit to provide adequate concentration formic acid;
a pump supplying water from the water storage unit to the mixer according to a control signal of the controller;
a pump supplying pure or high concentration formic acid from the pure or high concentration formic acid storage unit to the mixer according to a control signal of the controller; and
a pump supplying adequate concentration formic acid from the mixer to the anode.

7. The direct formic acid fuel cell according to claim 6, wherein the mixer is supplied with the formic acid discharged from the anode in order for the formic acid to be mixed together.

8. The direct formic acid fuel cell according to claim 2, wherein the concentration measuring device is a pH measuring device comprising a reference electrode composed of a calomel electrode, an Ag/AgCl electrode, or an Hg/Hg₂SO₄ electrode, and a body electrode composed of fluoro resin and epoxy resin.

9. The direct formic acid fuel cell according to claim 8, wherein an outer cover of the pH measuring device is made of polypropylene (PP), polyvinyl chloride (PVC), polyphenylene sulfide (PPS), carbon, polytetrafluoroethylene (PTFE), ethylene-propylene-diene-terpolymer (EPDM), alumina, nickel, SUS 316, or glass.

10. A method of operating a direct formic acid fuel cell, comprising:
measuring in real time a concentration of a portion of formic acid to be provided to an anode before the formic acid is provided to the anode (S1); and
comparing the measured concentration value with a predetermined concentration range, controlling in real time the concentration of formic acid to be supplied to the anode depending upon the real time measurement in such a manner that the measured concentration value does not deviate from the predetermined concentration range, and providing the anode with the formic acid (S2).

11. The method according to claim 10, wherein in the step S1, a pH value of hydrogen ions produced by dissociating a portion of formic acid is measured in real time before the formic acid is provided to the anode, and in the step S2, the measured pH value is compared with a predetermined pH range, the concentration of formic acid to be supplied to the anode is controlled in real time depending upon the real time pH measurement in such a mauler that the measured pH value does not deviate from the predetermined pH range, and provides the anode with the formic acid.

12. The method according to claim 11, wherein the pH measurement is carried out with reliability of 95% or more in connection with the variation in formic acid concentration in such a manner that upon variation in formic acid concentration, the measured pH value is stabilized into a constant value within 1 to 5 seconds.

13. The method according to claim 11, wherein the predetermined pH range is 1.34 to 0.42.

14. The method according to claim 10, wherein in the step S1, conductivity values of hydrogen ions and formate ions produced by dissociating a portion of formic acid is measured in real time before the formic acid is provided to the anode, and in the step S2, the measured conductivity value is compared with a predetermined conductivity range, the concentration of formic acid to be supplied to the anode is controlled in real time depending upon the real time conductivity measurement in such a manner that the measured conductivity values do not deviate from the predetermined conductivity range, and provides the anode with the formic acid.

15. The method according to claim 14, wherein the conductivity value is stabilized into a constant value within 1 to 5 seconds in connection with variation in formic acid concentration.

16. The method according to claim 14, wherein the predetermined conductivity range is 9.5 to 12 mS/cm.
